(19) United States
(12) Patent Application Publication
(10) Pub. No.: US 2015/0285723 A1
(43) Pub. Date: Oct. 8, 2015

(54) Viscosity Measurement Thermostatic Waterbath Device

(71) Applicant: SHENZHEN CHINA STAR OPTOELECTRONICS TECHNOLKOGY CO., LTD., Shenzhen, Guangdong (CN)

(72) Inventors: Weiwei Zhang, Shenzhen (CN); Rui Xu, Shenzhen (CN)

(21) Appl. No.: 14/362,125

(22) PCT Filed: Apr. 11, 2014
(86) PCT No.: PCT/CN2014/075142

§ 371 Date: Jun. 1, 2014

(30) Foreign Application Priority Data
Apr. 8, 2014 (CN) 201410138504.X

(51) Int. Cl. G01N 11/04; B01L 7/02

(52) U.S. Cl. CPC G01N 11/04; B01L 7/02; B01L 2300/123; B01L 2300/0861

(57) ABSTRACT

A viscosity measurement thermostatic waterbath device includes an outer container, an inner container embedded in the outer container's interior, and an interlayer set up between the outer container and the inner container. A circular cavity is formed between the interlayer and the outer container. By a interlayer set between inner and outer containers, the viscosity measurement thermostatic waterbath device provided in the present invention selects inner containers with different diameters according to different samples to be tested, in order to save testing materials and reduces test cost; moreover, by guaranteeing tightness of circular cavities, it lowers tightness requirement of the joint between inner and outer containers, simplifies joint component's structure, in order to make it easier to replace inner containers and reduce test cost.

### BACKGROUND OF THE INVENTION

1. Field of the Invention

The present invention relates to a display technology manufacture field, more particularly, to a viscosity measurement thermostatic waterbath device.

2. Description of the Prior Art

Due to advantages of slimness, energy saving and non-radiation, Liquid Crystal Display (LCD) is widely applied. Conventional LCDs in the market are mostly backlight LCDs comprising liquid crystal display panels and backlight modules. Liquid crystal display panels work by placing liquid crystal molecules between two parallel glass substrates, changing the direction of liquid crystal molecules through controlling by glass substrate voltage, and generating images through light refraction of backlight modules.

In the prior art, in manufacture procedure of liquid crystal display panel, conventional methods of filling liquid crystal in between glass substrates are traditional vacuum siphon method and one drop filling (ODF). Traditional vacuum siphon method is gradually absorbing liquid crystal through capillary theory after aligning upper and lower glass substrates; ODF is to aligning upper and lower glass substrates after instilling liquid crystal directly on glass. Comparing to traditional vacuum siphon method, ODF saves time to instill liquid crystal by a large margin, and saves liquid crystal material as well by greatly increase efficiency of utilization of liquid crystal. Therefore, when large size liquid crystal display panel becomes popular, ODF becomes the mainstream technology.

When manufacturing liquid crystal display panels applying ODF, laying on sealant around glass substrates is necessary for aligning upper and lower glass substrates. As the quality of sealant affects the quality of liquid crystal panels greatly, sealant material has to be highly endurable, reliable, precision solidifying and safe for manufacturing operation. Conventional sealant mainly made of acrylic resin and epoxy resin. As sealant viscosity affects the setting of manufacture parameters, strictly controlling sealant viscosity is necessary when laying on sealant Furthermore, as temperature greatly affects sealant viscosity, accurately controlling temperature is necessary when testing sealant viscosity.

When testing sealant viscosity, a viscosity measurement thermostatic waterbath device as FIG. 1 indicates is widely applied to control temperature precisely. The viscosity measurement thermostatic waterbath device comprises an outer container 110 and an inner container 120 embedded in the outer container 110 interior. The space in between the outer container 110 and the inner container 120 is a circular cavity 111 to hold circulating liquid; an in/out hole 112 is set up on the outer container 110. In usage, placing samples into the inner container 120, the dosage of which must surpass tick mark. Meanwhile, filling circulate liquid into the circular cavity 111 through the in/put pole 112 to control sample temperature in the inner container 120. However, when measuring viscosity of different samples, different rotors with different diameters must be disposed to a viscosimeter. Therefore, to measure viscosity of different samples, the diameter of the viscosity measurement thermostatic waterbath device must be greater than the diameter of the largest rotor. Hence sample is wasted when only smaller rotor is needed, and testing cost is expanded especially when testing samples with comparatively high cost Taking a rotor with 5 cm diameter and a 7 cm tick mark for instance, roughly 150 ml sample is needed. Given the price of sealant is 10˜20 RMB/g, the cost of sample in one test is above 1500 RMB, undoubtedly a massive waste.

### SUMMARY OF THE INVENTION

It is therefore a primary object of the present invention to provide a viscosity measurement thermostatic waterbath device suitable for inner containers with different diameters in purpose of solving the problems of conventional art mentioned above.

According to the present invention, a viscosity measurement thermostatic waterbath device comprises an outer container, an inner container embedded in the outer container's interior, and an interlayer set up between the outer container and the inner container. A circular cavity is formed between the interlayer and the outer container.

In one aspect of the present invention, the interlayer is made of flexible material.

In another aspect of the present invention, the viscosity measurement thermostatic waterbath device further comprises a supporting structure set up within the circular cavity, and the supporting structure bloats the interlayer into a bursiform, an opening of which is used to hold the inner container.

In another aspect of the present invention, the supporting component comprises a plurality of fixed connecting arms with one end fixedly connected to the outer container and the other end connected to a plurality of supporting arms, the plurality of supporting arms form a closed or a non-closed ring, where part of the interlayer locates and forms an opening in bursiform.

In another aspect of the present invention, the supporting arms are made of flexible material.

In another aspect of the present invention, a distance of two joints of the fixed connecting arms and supporting arms is less than a diameter of a ring circled by the supporting arms.

In another aspect of the present invention, the supporting arms are hinged with the fixed connecting arms, and an elastic member is set up to prompt the supporting arms into a closed ring.

In another aspect of the present invention, the elastic member is a spring.

In still another aspect of the present invention, the interlayer is made of latex material.

In yet another aspect of the present invention, the outer container and the inner container are both made of rigid material.

Benefits of the present invention are:

By a interlayer set between inner and outer containers, the viscosity measurement thermostatic waterbath device provided in the present invention selects inner containers with different diameters according to different samples to be tested, in order to save testing materials and reduces test cost; moreover, by guaranteeing tightness of circular cavities, it lowers tightness requirement of the joint between inner and outer containers, simplifies joint component's structure, in order to make it easier to replace inner containers and reduce test cost.

### BRIEF DESCRIPTION OF THE DRAWINGS

FIG. 1 shows a structure of a conventional viscosity measurement thermostatic waterbath device.

FIG. 2 shows a structure of a viscosity measurement thermostatic waterbath device according to a first embodiment of the present invention, where

FIG. 2a shows an outer container,

FIG. 2b shows an interlayer and the outer container,

FIG. 2c shows an inner container, and

FIG. 2d shows a cross-section view of the viscosity measurement thermostatic waterbath device.

FIG. 3 shows a structure of a viscosity measurement thermostatic waterbath device according to a second embodiment of the present invention, where

FIG. 3a shows an outer container,

FIG. 3b shows cross-section view of an interlayer and the outer container,

FIG. 3c shows an inner container, and

FIG. 3d shows a top view of the viscosity measurement thermostatic waterbath device embedding inner contains with various diameters.

FIG. 4 shows a schematic diagram of a supporting component according to a third embodiment of the present invention, where

FIG. 4a shows the supporting arm opening, and

FIG. 4b shows the supporting arm closing.

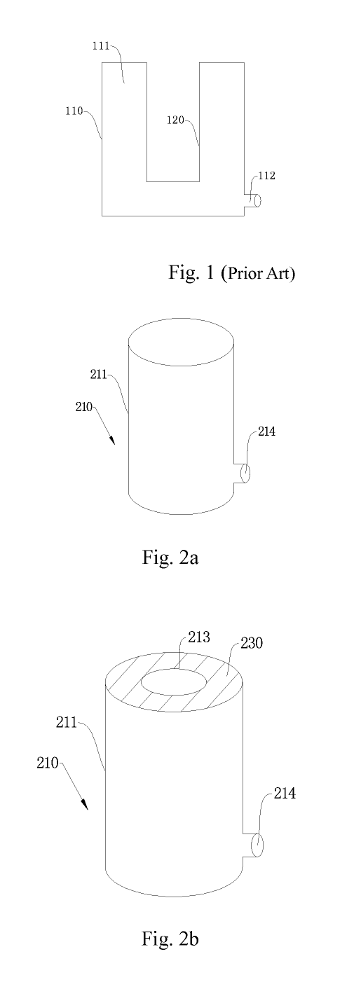

### DETAILED DESCRIPTION OF THE PREFERRED EMBODIMENTS

As mentioned above, the primary object of the present invention is to provide a viscosity measurement thermostatic waterbath device suitable for inner containers with different diameters, in purpose of reducing test cost. The viscosity measurement thermostatic waterbath device comprises an outer container, an inner container embedded in the outer container's interior, and an interlayer set up between the outer container and the inner container. A circular cavity is formed between the interlayer and the outer container.

In order to illustrate the technique and effects of the present invention, a detailed description will be disclosed by the following disclosure in conjunction with figures. Please note, the same components are labeled by the same number.

### Embodiment 1

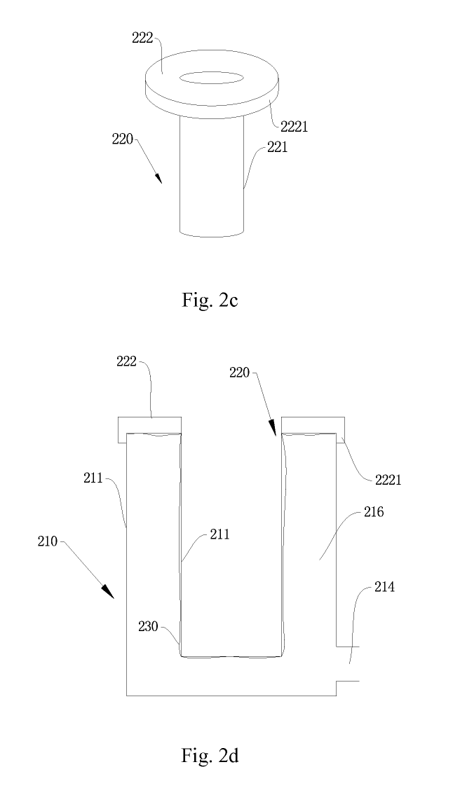

Please refer to FIG. 2. A viscosity measurement thermostatic waterbath device in the embodiment comprises an outer container 210, an inner container 220 embedded in the outer container 210 interior, and an interlayer 230 set up in between the outer container 210 and the inner container 220. The interlayer 230 tightly seals with the outer container 210 in the opening of the outer container 210. In between the outer container 210 and the interlayer 230 forms a circular cavity 216 to hold circulating liquid which enters the circular cavity 216 from an in/out hole 214 set up on side wall of the outer container 210. In usage, place the inner container 220 inside the interlayer 230 and make them fit snugly, in order that the circulating liquid accurately controls temperature of samples inside the inner container 220.

To make sure the interlayer 230 fit snugly with the inner containers 220 with different diameters, the interlayer 230 is made of flexible material, meanwhile the inner container 220 and the outer container 210 are made of rigid material. Preferably, the interlayer 230 is made of latex material, so that it is comparatively thin and highly flexible. When the inner container 220 is embedded inside the interlayer 230, the pressure of the liquid in the circular cavity 216 forces the interlayer 230 to fit snugly with the inner container 220, so that uniform heating of the inner container 220 is guaranteed, and accurately controlling temperature of samples inside the inner container 220 is possible.

Please refer to FIG. 2b. The embodiment also comprises a supporting component 212 comprising a plurality of fixed connecting arms 2121 with one end fixedly connected to the outer container 210 and the other end connected to a supporting arm 213. In the embodiment, the supporting arm is an elastic ring which bloats the interlayer 230 into a bursiform through the supporting component 212. In other words, the supporting component 212 is set up inside the circular cavity 216, while part of the interlayer 230 locates inside the elastic ring and forms an opening in bursiform jointing to an elastic ring set up in the circular cavity 216. The elastic ring is made of flexible material. In one embodiment, the elastic ring is a rubber band having merits of good extensibility, good rebound elasticity and convenient utility. When testing samples, undraw the elastic ring, and place the inner container 220 inside the interlayer 230. Likewise, when testing is done, undraw the elastic ring and fetch out the inner container 220, or draw off the inner container 220 directly, which facilitates placing and drawing of the inner containers 220 with different diameters.

Please refer to FIG. 2c and FIG. 2d. To prevent the inner container 220 from leaning in testing resulting in a failing test, the inner container 220 comprises a side wall 221 and a fixing wall 222 which is formed by a ring structure through outward extension of the opening of the inner container 220. The diameter of the fixing wall 222 is larger than the diameter of the opening of the outer container 210. Therefore, in usage, embedding the inner container 220 inside the interlayer 230 supports the inner container 220, for the fixing wall 222 locates on the outer container 210.

Diameter of the fixing wall 222 matches diameter of the opening of the outer container 210. Moreover, a clamping unit 2221 with downward protrusion is set up on the fixing wall 222, so that the fixing wall 222 covers on the outer container 210 to prevent horizontal movement of the inner container 220 in testing.

The viscosity measurement thermostatic waterbath device provided in the embodiment selects inner containers with different diameters according to different samples to be tested, in order to save testing materials and reduce test cost; moreover, it lowers tightness requirement of the joint between inner and outer containers, simplifies joint component's structure, in order to make it easier to replace inner containers and reduce test cost. Meanwhile, the viscosity measurement thermostatic waterbath device has merits of simple structure and convenient usage.

### Embodiment 2

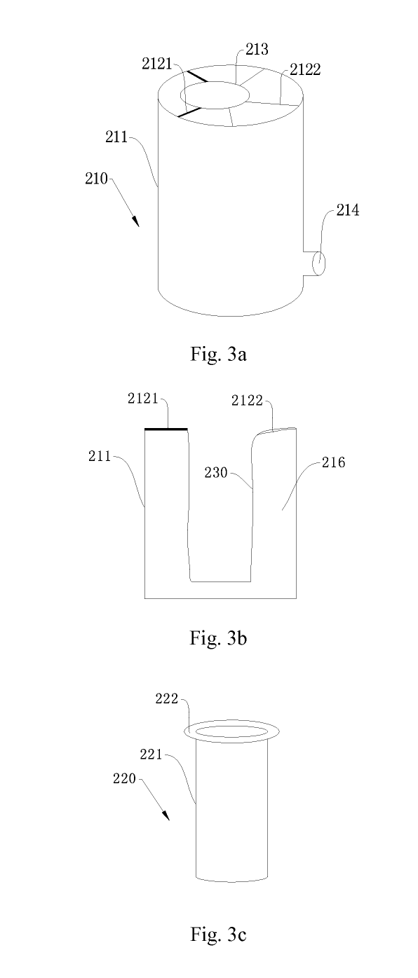

Please refer to FIG. 3. A viscosity measurement thermostatic waterbath device in the embodiment comprises an outer container 210, a inner container 220 embedded in the outer container 210 interior, and an interlayer 230 set up in between the outer container 210 and the inner container 220. The interlayer 230 tightly seals with the outer container 210 in the opening of the outer container 210. In between the outer container 210 and the interlayer 230 forms a circular cavity 216 to hold circulating liquid which enters the circular cavity 216 from a in/out hole 214 set up on side wall of the outer container 210. In usage, place the inner container 220 inside the interlayer 230 and make them fit snugly, in order that the circulating liquid accurately controls temperature of samples inside the inner container 220.

To make sure the interlayer 230 fit snugly with the inner containers 220 with different diameters, the interlayer 230 is made of flexible material, meanwhile the inner container 220 and the outer container 210 are made of rigid material. Preferably, the interlayer 230 is made of latex material, so that it is comparatively thin and highly flexible. When the inner container 220 is embedded inside the interlayer 230, the pressure of the liquid in the circular cavity 216 forces the interlayer 230 to fit snugly with the inner container 220, so that uniform heating of the inner container 220 is guaranteed, and accurately controlling temperature of samples inside the inner container 220 is possible.

Please refer to FIG. 3a and FIG. 3b. The embodiment also comprises a supporting component 212 comprising a plurality of fixed connecting arms 2121 with one end fixedly connected to the outer container 210 and the other end connected to a supporting arm 213. In the embodiment, the supporting arm is an elastic ring which bloats the interlayer 230 into a bursiform through the supporting component 212. In other words, the supporting component 212 is set up inside the circular cavity 216, while part of the interlayer 230 locates inside the elastic ring and forms an opening in bursiform jointing to an elastic ring set up in the circular cavity 216. The elastic ring is made of flexible material. In one embodiment, the elastic ring is a rubber band having merits of good extensibility, good rebound elasticity and convenient utility. The elastic ring connects to the outer container 210 through a plurality of the fixed connecting arms 2121, whereof the elastic ring and the fixed connecting arms 2121 are set up inside the circular cavity 216. In the embodiment, the elastic ring fixedly connects to the outer container 210 through two fixed connecting arms 2121, and the shortest distance of the two fixed connecting arms 2121 must be less than diameter of the inner container 220. The elastic ring is also connected to the outer container 210 through an elastic connecting arm 2122 coming with itself. The elastic connecting arm 2122 is set up inside the circular cavity 216. The fixed connecting arms 2121 and the elastic connecting arm 2122 limit the position of the elastic ring; meanwhile, the elastic connecting arm 2122 is used to change a size of the opening of the interlayer 230.

Please refer to FIG. 3c. The inner container 220 comprises a side wall 221 and a cover 222 which is formed by a ring extended from the opening of the inner container 220. In usage, the elastic ring fits snugly on the side wall 221 below the cover 222. The cover 222 prevents the inner container 220 from sinking into the interlayer 230, meanwhile facilitates fetching and drawing of the inner container 220.

### Embodiment 3

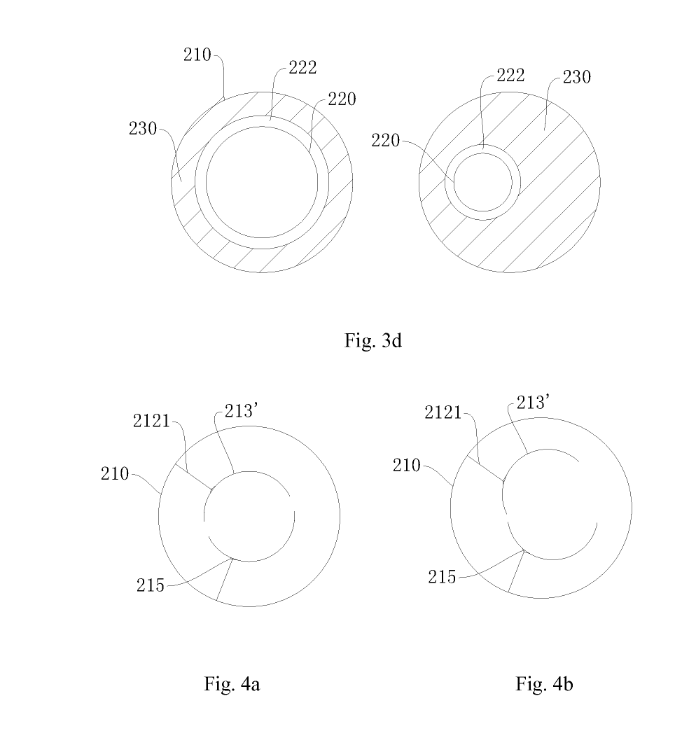

The embodiment differs the foregoing two embodiments in the structure of the supporting component 212. As FIG. 4 indicates, the supporting component 212 comprises two fixed connecting arms 2121 with one end fixedly connected to the outer container 210 and the other end connected to a supporting arm 213′. These two supporting arms 213′ form a non-closed ring, in which part of the interlayer 230 locates and forms an opening in bursiform. The distance of the joints of two fixed connecting arms 2121 and supporting arms 213′ is smaller than the diameter of the ring formed by supporting arms 213′. Moreover, the supporting arms 213′ and the fixed connecting arms 2121 are hinge structure. In other words, the supporting arms 213's can open and the ring's inner diameter can be expanded resulting in a larger gap. For tightly clamping, an elastic member 215 which is a spring is also set up to prompt the supporting arms into a closed ring. This structure can also be used to replace inner containers 220 with different diameters.

In conclusion, by a interlayer set between inner and outer containers, the viscosity measurement thermostatic waterbath device provided in the present invention selects inner containers with different diameters according to different samples to be tested, in order to save testing materials and reduces test cost; moreover, by guaranteeing tightness of circular cavities, it lowers tightness requirement of the joint between inner and outer containers, simplifies joint component's structure, in order to make it easier to replace inner containers and reduce test cost.

The terms “a” or “an”, as used herein, are defined as one or more than one. The term “another”, as used herein, is defined as at least a second or more. The terms “including” and/or “having” as used herein, are defined as comprising. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A viscosity measurement thermostatic waterbath device comprising an outer container, an inner container embedded in the outer container's interior, and an interlayer set up between the outer container and the inner container, wherein a circular cavity is formed between the interlayer and the outer container.

2. The viscosity measurement thermostatic waterbath device of claim 1, wherein the interlayer is made of flexible material.

3. The viscosity measurement thermostatic waterbath device of claim 1 further comprising a supporting structure set up within the circular cavity, and the supporting structure bloats the interlayer into a bursiform, an opening of which is used to hold the inner container.

4. The viscosity measurement thermostatic waterbath device of claim 2 further comprising a supporting structure set up within the circular cavity, and the supporting structure bloats the interlayer into a bursiform, an opening of which is used to hold the inner container.

5. The viscosity measurement thermostatic waterbath device of claim 3, wherein the supporting component comprises a plurality of fixed connecting arms with one end fixedly connected to the outer container and the other end connected to a plurality of supporting arms, the plurality of supporting arms form a closed or a non-closed ring, where part of the interlayer locates and forms an opening in bursiform.

6. The viscosity measurement thermostatic waterbath device of claim 4, wherein the supporting component comprises a plurality of fixed connecting arms with one end fixedly connected to the outer container and the other end connected to a plurality of supporting arms, the plurality of supporting arms form a closed or a non-closed ring, where part of the interlayer locates and forms an opening in bursiform.

7. The viscosity measurement thermostatic waterbath device of claim 5, wherein the supporting arms are made of flexible material.

8. The viscosity measurement thermostatic waterbath device of claim 6, wherein the supporting arms are made of flexible material.

9. The viscosity measurement thermostatic waterbath device of claim 5, wherein a distance of two joints of the fixed connecting arms and supporting arms is less than a diameter of a ring circled by the supporting arms.

10. The viscosity measurement thermostatic waterbath device of claim 6, wherein a distance of the two joints of the two fixed connecting arms and supporting arms is less than a diameter of a ring circled by the supporting arms.

11. The viscosity measurement thermostatic waterbath device of claim 9, wherein the supporting arms are hinged with the fixed connecting arms, and an elastic member is set up to prompt the supporting arms into a closed ring.

12. The viscosity measurement thermostatic waterbath device of claim 10, wherein the supporting arms are hinged with the fixed connecting arms, and an elastic member is set up to prompt the supporting arms into a closed ring.

13. The viscosity measurement thermostatic waterbath device of claim 11, wherein the elastic member is a spring.

14. The viscosity measurement thermostatic waterbath device of claim 12, wherein the elastic member is a spring.

15. The viscosity measurement thermostatic waterbath device of claim 1, wherein the interlayer is made of latex material.

16. The viscosity measurement thermostatic waterbath device of claim 2, wherein the interlayer is made of latex material.

17. The viscosity measurement thermostatic waterbath device of claim 1, wherein the outer container and the inner container are both made of rigid material.

18. The viscosity measurement thermostatic waterbath device of claim 2, wherein the outer container and the inner container are both made of rigid material.
